(19) United States
(12) Patent Application Publication
(10) Pub. No.: US 2012/0202966 A1
(43) Pub. Date: Aug. 9, 2012

(54) METHOD FOR PRODUCING POLYESTERS AND CO-POLYESTERS FROM LACTONES

(75) Inventors: Emmanouil Spyrou, Schermbeck (DE); Friedrich Georg Schmidt, Haltern am See (DE); Susanne Kreischer, Herten (DE); Andrea Voecker, Ahaus (DE); Elke Gollan, Herne (DE); Helmut Ritter, Wuppertal (DE); Jiawen Zhou, Karlsruhe (DE)

(73) Assignee: Evonik Degussa GmbH, Essen (DE)

(21) Appl. No.: 13/501,187

(22) PCT Filed: Aug. 12, 2010
(86) PCT No.: PCT/EP10/61755

§ 371 Date: Apr. 10, 2012

(30) Foreign Application Priority Data
Oct. 14, 2009 (DE) 102009045664.3

(51) Int. Cl. C08G 63/85

(52) U.S. Cl. 528/356

(57) ABSTRACT

The invention relates to a method for producing polyesters and co-polyesters from lactones

The application describes a process for preparing polyesters and copolyesters from lactones.

Lactones (cyclic esters) can be polymerized by compounds containing active hydrogen (known as starters), such as alcohols or amines, in the presence of catalysts at temperatures from 20 to 200° C. Where only one lactone is used, the reaction products are referred to as polyesters or polylactones; the use of two or more different lactones results in copolyesters or else copolylactones.

The preparation of polyesters and copolyesters from lactones has frequently already been studied. In addition to metal-catalyzed polymerizations of the kind described, for example, in Kowalski, A. et al. Macromolecules, 2000, 33, 689-695, or in Chem, H. L. et al. Organometallics, 2001, 23, 5076-5083, there are also anionic initiated (Cherdron, H. et al., Makromol. Chem. 1962, 56, 179), cationic initiated (Basko, M. et al., J. Polym. Chem., 2006, 44, 7071-7081), and lipase-catalyzed polymerizations (Ritter, H. et al. Adv. Polym. Sci., 2006, 194, 95) known. The use of solid-phase catalysts as well has already been described, in DE 32 21 692, for example.

All of these preparation procedures have the disadvantage either that high temperatures and long reaction times are required, leading to discoloration and side reactions, or else that the preparation processes cannot be adequately applied to less-reactive substituted lactones.

It was an object of the invention to find a preparation process for polyesters and copolyesters from lactones which first proceeds at low temperatures and second can also be applied to less-reactive substituted lactones.

Surprisingly it has been found that through the use of bismuth triflate as catalyst it is possible to polymerize not only simple but also less-reactive (e.g., substituted) lactones at low temperatures preferably of not more than 100° C. to give polyesters and/or copolyesters. Additionally it has been found that the catalyst of the invention significantly reduces the reaction time.

The invention provides a process for preparing polyesters and copolyesters by reacting

A) at least one lactone,
B) at least one alcohol or amine as starter, and
C) in the presence of bismuth triflate as catalyst.

The process is applied preferably at temperatures of not more than 100° C., more preferably from room temperature to 80° C.

Suitable lactones A) are all cyclic esters having 3-20 ring atoms and optionally one or more further substituents on the ring. These substituents may simultaneously or independently of one another be alkyl, aryl, aralkyl, heteroaryl, alkoxyalkyl radicals having 1-18 carbon atoms, in each case linear or branched, unbridged or bridged with other radicals, to form cyclic, bicyclic or tricyclic systems, it being possible for the bridging atoms to be not only carbon but also heteroatoms, and for each radical, additionally, to have one or more alcohol, amino, ether, ester, keto, thio, urethane, urea, allophanate groups, double bonds, triple bonds or halogen atoms. Suitable lactones are, for example, ε-caprolactone, γ-butyrolactone, β-propiolactone, β-methylpropiolactone, 3,3,5- and 3,5,5-trimethyl-ε-caprolactone, γ-valerolactone, β-methyl-δ-valerolactone. Mixtures of such monomers can also be used. Preference is given to ε-caprolactone and 3,3,5- and 3,5,5-trimethyl-ε-caprolactone, particular preference to mixtures of ε-caprolactone and 3,3,5- and 3,5,5-trimethyl-ε-caprolactone.

Suitable starters under B) are all monomeric, oligomeric or polymeric mono- or polyalcohols or amines. Examples of alcohols are ethanol, propanol, butanol, monoethylene glycol, 1,2- and 1,3-propylene glycol, 1,4- and 2,3-butylene glycol, di-μ-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxy-methyl)tricyclo[5.2.1.0^{2.6}]decane (Dicidol), bis(1,4 hydroxymethyl)cyclohexane, 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4-trimethylhexane-1,6-diol, 2,4,4-trimethylhexane-1,6-diol, glycerol, trimethylolpropane, trimethylolethane, hexane-1,2,6-triol, butane-1,2,4-triol, tris(β-hydroxyethyl)isocyanurate, pentaerythritol, mannitol, sorbitol, diethylene glycol, triethylene glycol, tetraethylene glycol, dipropylene glycol, polypropylene glycols, polybutylene glycols, xylylene glycol, neopentyl glycol hydroxypivalate, and polytetrahydrofurans. Examples of amines are propanamine, butanamine, ethylenediamine, propylenediamine, hexamethylenediamine, 2,2,4- and 2,4,4-trimethylhexamethylenediamine, diethylenetriamine, triethylenetetramine, 4,4′-dicyclohexylmethyldiamine, isophoronediamine, aminated polyethers (trade name Jeffamines). Mixtures of the starters B) can also be used.

Preference is given to using neopentyl glycol, butanediol or trimethylolpropane, alone or in mixtures.
The amount of B) is used so as to result in polyesters which possess an OH number of 5-500. This means that, according to the molar mass and functionality of B), it has a proportion in the overall formulation of 1-90% by weight, preferably 3-35% by weight.

Bismuth triflate is used as catalyst C. Triflate here is the common abbreviation for salts of trifluoromethylsulfonic acid. The empirical formula of the catalyst is Bi(F₃CSO₃)₃. It is used in amounts of 0.01% to 2% by weight, based on the overall formulation, preferably at 0.1% to 1% by weight.

The catalyst is available commercially, for example, from Acros.

Using the process of the invention, polyesters having any desired degrees of polymerization can be prepared. The degree of polymerization is determined by the equivalents ratio of starter molecules to lactone. Since polyesters having an average molar mass (Mn) of 300 to 10 000 g/mol are of particular technical interest, the required starter-lactone ratios can be set via the stoichiometry. It is preferred to prepare polyesters with an Mn of 300 to 10 000 g/mol, an OH number of 5-400 mg KOH/g, an acid number of 0-20 mg KOH/g, and a monomer content of 0-20% by weight, based on the overall formulation.

In principle it is possible to deactivate the catalyst after the preparation of the polyester or copolyester. Suitability for such deactivation is possessed in particular by basic compounds, which are used in concentrations of 0.1-2% by weight. Suitable examples include amines, such as preferably triethylamine, or methyl ethyl ketoximes, or else metal salts of carboxylic acids, preferably, for example, sodium acetate.

Examples of reaction assemblies contemplated for the reaction include heatable stirred tanks, reaction tubes, static mixers, compounders or else extruders. The starting products and the end product of the invention may be solid or liquid. The reaction temperature ought preferably to be selected such that all of the constituents are present in liquid form in the same phase. The temperature, however, ought to be below 100° C., preferably below 80° C., more preferably below 70° C. The reaction time amounts to between a few minutes and several hours, or even days in exceptional cases. The reaction time is preferably 30 minutes to 6 hours. The reaction can also be carried out in inert solvents, but is preferably operated solventlessly. The reaction may preferably be conducted such that hardly any lactone remains in the reaction mixture, preferably <0.5% by weight, or else excess lactone can be separated off by distillation after the reaction and introduced back into the next preparation procedure.

The average molar mass (Mn) is determined as follows: ASTM D 3016-78, ASTM D 3536-76, ASTM D 3593-80, GPC (gel permeation chromatography).

In the case of the copolymerization of two or more lactones having significantly different reactivities it has been found appropriate to introduce the less-reactive lactone or lactones to start with and to add the more-reactive lactone or lactones in portions during the reaction.

The invention also provides the polyesters and copolyesters prepared by the process of the invention.

The polyesters prepared by the process are suitable, for example, for producing polyurethanes.

Below, the invention is illustrated with examples, but not restricted.

### EXAMPLES

### A) Starting Materials

| Starting materials | Product description, manufacturer |
|---|---|
| ε-Caprolactone | Aldrich |
| Mixture of 3,3,5- and | Preparation described in JP09124637 |
| 3,5,5-trimethyl-ε- | |
| caprolactone | |
| Bismuth triflate | Aldrich |
| NPG | Neopentyl glycol, Aldrich |

### B) Preparation of the Polyesters

1) Use of ε-caprolactone

114 g of ε-caprolactone and 12.5 g of NPG are admixed with 0.6 g of bismuth triflate and stirred at 60° C. for 30 minutes. After this reaction time, a polyester results which has an OH number of 103 mg KOH/g, a monomer content of <0.1% by weight, and an average molar mass (Mn) of 1700 g/mol (GPC).

2) Use of trimethyl-ε-caprolactone

156 g of a mixture of 3,3,5- and 3,5,5-trimethyl-ε-caprolactone and 12.5 g of NPG are admixed with 0.6 g of bismuth triflate and stirred at 60° C. for 200 minutes. After this reaction time, the residual amount of trimethyl-ε-caprolactone monomer (15.9% by weight) is separated off by distillation (short-path evaporator 70° C., 0.1 mbar). This results in a polyester having an OH number of 93 mg KOH/g, a monomer content of 1.2% by weight, and an average molar mass (Mn) of 1500 g/mol (GPC).

3) Use of a mixture of ε-caprolactone and trimethyl-ε-caprolactone 46.8 g of a mixture of 3,3,5- and 3,5,5-trimethyl-ε-caprolactone are admixed with 12.5 g of NPG and with 0.6 g of bismuth triflate and heated to 60° C. Then 79.8 g of ε-caprolactone are added dropwise over the course of 200 minutes at 60° C. with stirring. After this reaction time, the residual amount of trimethyl-ε-caprolactone monomer is separated off by distillation (4.5% by weight). This results in a polyester having an OH number of 99 mg KOH/g, a monomer content (trimethyl-ε-caprolactone) of 1.1% by weight, and an average molar mass (Mn) of 1500 g/mol (GPC).

A) Noninventive Comparative Experiment

The same starting mixture as in 2) is used, but instead of bismuth triflate the same amount of a customary catalyst is used, 0.6 g of tin octoate. After 15 hours at 130° C., there is still about 30% by weight of trimethylcaproclactone remaining in the reaction mixture.

As the examples show, only bismuth triflate is capable of converting even low-reactivity lactones into the corresponding polyesters at low temperatures and in short reaction times.

1: A process for preparing a polyester, a copolyester, or both, the process comprising reacting
A) a lactone, and
B) an alcohol or amine as a starter, in the presence of bismuth triflate as a catalyst.

2: The process of claim 1,
wherein a temperature of the reacting is not more than 100° C.

3: The process of claim 1,
wherein the lactone is an optionally substituted lactone having 3-20 ring atoms.

4: The process of claim 3,
wherein the lactone is ε-caprolactone, γ-butyrolactone, β-propiolactone, β-methylpropiolactone, 3,3,5-trimethyl-ε-caprolactone, 3,5,5-trimethyl-ε-caprolactone, γ-valerolactone, β-methyl-δ-valerolactone, or a mixture thereof.

5: The process of claim 4,
wherein the lactone is ε-caprolactone, or 3,3,5-trimethyl-ε-caprolactone, 3,5,5-trimethyl-ε-caprolactone, or a mixture thereof.

6: The process of claim 1,
wherein the starter is ethanol, propanol, butanol, monoethylene glycol, 1,2-propylene glycol, 1,3-propylene glycol, 1,4-butylene glycol, 2,3-butylene glycol, di-β-hydroxyethylbutanediol, 1,5-pentanediol, 1,6-hexanediol, 1,8-octanediol, decanediol, dodecanediol, neopentyl glycol, cyclohexanediol, 3(4),8(9)-bis(hydroxymethyl)tricyclo[5.2.1.0^{2.6}]decane (Dicidol), bis(1,4 hydroxymethyl)cyclohexane, 2,2-bis(4-hydroxycyclohexyl)propane, 2,2-bis[4-(β-hydroxyethoxy)phenyl]propane, 2-methylpropane-1,3-diol, 2-methylpentane-1,5-diol, 2,2,4-trimethylhexane-1,6-diol, 2,4,4-trimethylhexane-1,6-diol, glycerol, trimethylolpropane, trimethylolethane, hexane-1,2,6-triol, butane-1,2,4-triol, tris(β-hydroxyethyl)isocyanurate, pentaerythritol, mannitol, sorbitol, diethylene glycol, triethylene glycol, tetraethylene glycol, dipropylene glycol, polypropylene glycol, polybutylene glycol, xylylene glycol, neopentyl glycol hydroxypivalate, polytetrahydrofuran, propanamine, butanamine, ethylenediamine, propylenediamine, hexamethylenediamine, 2,2,4-trimethylhexamethylenediamine, 2,4,4-trimethylhexamethylenediamine, diethylenetriamine, triethylenetetramine, 4,4′-dicyclohexylmethyldiamine, isophoronediamine, aminated polyether, or a mixture thereof.

7: The process of claim 1,
wherein the starter is neopentyl glycol, butanediol, trimethylolpropane, or a mixture thereof.

8: The process of claim 1,
wherein the starter is from 1 to 90% by weight of an overall formulation of the reacting.

9: The process of claim 1,
wherein the catalyst Bi(F₃CSO₃)₃ is from 0.01% to 2% by weight of an overall formulation of the reacting.

10: The process of claim 1,
wherein the process produces a polyester with a number average molar mass (Mn) of from 300 to 10 000 g/mol.

11: The process of claim 1,
wherein the process produces a polyester with a number average molecular weight Mn of from 300 to 10 000 g/mol, an OH number of from 5 to 400 mg KOH/g, an acid number of from 0 to 20 mg KOH/g, and a monomer content of from 0 to 20% by weight, based on an overall formulation of the reacting.

12: The process of claim 1,
wherein the process is not in the presence of a solvent.

13: The process of claim 1,
wherein either an amount of lactone in a mixture of the reacting is <0.5% by weight, or wherein the process further comprises separating off excess lactone by distillation after reacting.

14: The process of claim 1, further comprising:
deactivating the catalyst after preparing the polyester or copolyester.

15: A polyester or copolyester obtained by a process comprising the process of claim 1.

16: The process of claim 2, wherein the temperature of the reacting is from room temperature to 80° C.

17: The process of claim 5,
wherein the lactone is a mixture of ε-caprolactone, 3,3,5- trimethyl-ε-caprolactone, and 3,5,5-trimethyl-ε-caprolactone.

18: The process of claim 8,
wherein the starter is from 3 to 35% by weight of the overall formulation.

19: The process of claim 9,
wherein the catalyst is from 0.1% to 1% by weight of the overall formulation.

20: The process of claim 14,
wherein deactivating the catalyst comprises deactivating the catalyst with a basic compound.
